(19) United States
(12) Patent Application Publication
(10) Pub. No.: US 2015/0235102 A1
(43) Pub. Date: Aug. 20, 2015

(54) DETECTING A TARGET IN A SCENE

(71) Applicant: BAE SYSTEMS PLC, London (GB)

(72) Inventor: Adrian Simon Blagg, Bristol (GB)

(73) Assignee: BAE SYSTEMS plc, London (GB)

(21) Appl. No.: 14/430,089

(22) PCT Filed: Sep. 12, 2013
(86) PCT No.: PCT/GB2013/052387

§ 371 Date: Mar. 20, 2015

(30) Foreign Application Priority Data
Sep. 20, 2012 (GB) 1216818.3
Oct. 8, 2012 (GB) 1217999.0

(51) Int. Cl. G06K 9/52; G06K 9/62

(52) U.S. Cl. CPC G06K 9/52; G06K 9/6202; G06K 2009/4657

(57) ABSTRACT

A system and method are disclosed for detecting a target within a scene. The system comprises a sensor for acquiring hyperspectral image data of the scene, a repository for storing a set of target spectra and a processor for processing spectra generated from locations within the scene with the known set of target spectra. The processor is further arranged to generate a probability that the spectra generated from locations within the scene correspond with one or more target spectra based on the comparison between the spectra generated from locations within the scene with the target spectra.

The present invention is concerned with a method and system of detecting a target in a scene.

Current methods of detecting targets, such as people, include the use of thermal imagery systems. However, it can be difficult to discriminate people from other hot objects of similar apparent size using thermal imagery systems.

This work has looked at developing an approach based upon hyperspectral processing that can assist in the unique identification of people targets in sensing scenarios, and aims to use hyperspectral processing to complement the thermal approach and allow a higher level of confidence in identifying and discriminating people in a scene from other features within the scene.

According to a first aspect of the present invention, there is provided a method of detecting a target within a scene, the method comprising:

acquiring hyperspectral image data of a scene;

processing the hyperspectral image data to compare spectra generated from locations within the scene with a known set of target spectra;

generating a map of a probability that the spectra generated from locations within the scene correspond with one or more target spectra, based on the comparison between the spectra generated from locations within the scene with the target spectra.

Advantageously, the method provides for the detection of a broad, spectrally ill-defined, set of targets, such as “people” objects. This allows for all (or at least most) targets within a scene to be identified using a database of only a few example target spectra, rather than an uncertainly large database of all possible target spectra, which is an unrealistic proposition.

Preferably, the hyperspectral image data is converted to reflectance data, characteristic of objects within the scene.

The algorithm is based upon a collection of material spectra, recorded under laboratory conditions, which are compared with a captured scene. Spectra which are similar to one or more of these pre-recorded spectra are considered more likely to contain an object which may indicate a person. This problem is challenging, as people can wear a wide variety of items, and hence can display a large variety of spectral features depending upon their attire. However, by combining the spectral approach and the thermal approach currently in use, it is thought that improved combined detection rates can be achieved due to the different nature of the false targets each system is expected to produce.

Preferably, the processing of the hyperspectral image data comprises matched filter processing. The matched filter processing comprises two separate techniques for comparing spectra generated from locations within the scene with the known set of target specific spectra. Preferably, the separate comparison techniques separately comprise relating a level of comparison to a threshold.

In an embodiment of the present invention, the processing of the hyperspectral image data is performed according to an algorithm, which utilises an adaptive cosine estimator and a spectral angle mapper. The algorithm works by performing matched filter detections of the database spectra, on the scene in question. The filter results are then loosely thresholded such that most false alarms are still included in the result, as a number of spectra within the scene are likely to form part of the broad set of target spectra. Combining these results means that objects or features within the scene which generate a high response in one filter result (namely those which may be representative of an actual target, or a feature generating a spectra very similar to a target) or less high results in several (namely objects in the scene which generate spectra which are not specifically defined in the database, but appear similar to several sample spectra) appear with high likelihoods of being in the particular set of targets. The database construction, thresholding and final combination weightings is carefully adjusted to ensure good coverage of the broad set.

In an embodiment, the method further comprises the step of highlighting the targets identified from the hyperspectral image data, on a view of the scene. Preferably, the method further comprises acquiring thermal image data of the scene and comparing the targets identified using the hyperspectral image data with targets identified using thermal imaging data.

In a further embodiment, the method may further comprise the step of selecting a background of the scene from a plurality of types of scene backgrounds, to improve the accuracy of the processed spectra by providing a more accurate estimate of background covariance. Also, the method may further comprise calibrating the hyperspectral image data according to atmospheric conditions, so that the observed spectra can be converted to source reflectance.

It is envisaged that the algorithm may be expanded in two ways. Firstly alternative matched filter style algorithms could be used at the first stage. This may involve minor adjustments to the thresholding/combining portion; for example, some matched filters produce low results on targets as opposed to high results—thus requiring “1-result” to be used for the final combination. Indeed, possibly increasing the number of component matched filters above 2 may be of benefit. In this respect, the exact nature of the database may vary with each implementation to suit the particular scenario. Secondly, other spectrally broad, ill-defined set of objects may be detectable by this manner of approach. For example, cars or possibly even ‘damage’, namely objects displaying signs of being damaged or in a poor state of repair. Depending on the nature of these further sets of objects, thermal imagery may or may not be a useful means of comparison

According to a second aspect of the present invention, there is provided a system for detecting a target within a scene, the system comprising:

a sensor for acquiring hyperspectral image data of a scene;

a repository for storing a set of target spectra;

a processor for processing spectra generated from locations within the scene with the stored set of target spectra, the processor being further arranged to generate a probability that the spectra generated from locations within the scene correspond with one or more target spectra.

The system may further comprise a thermal imaging sensor for acquiring thermal image data of the scene, and a display for displaying a view of the scene. In an embodiment, the display is arranged to display the location of targets identified from the hyperspectral image data and the thermal image data, to provide a user of the system with a visual validation of the identified target.

An embodiment of the present invention will now be described by way of example only and with reference to the accompanying drawings, in which:

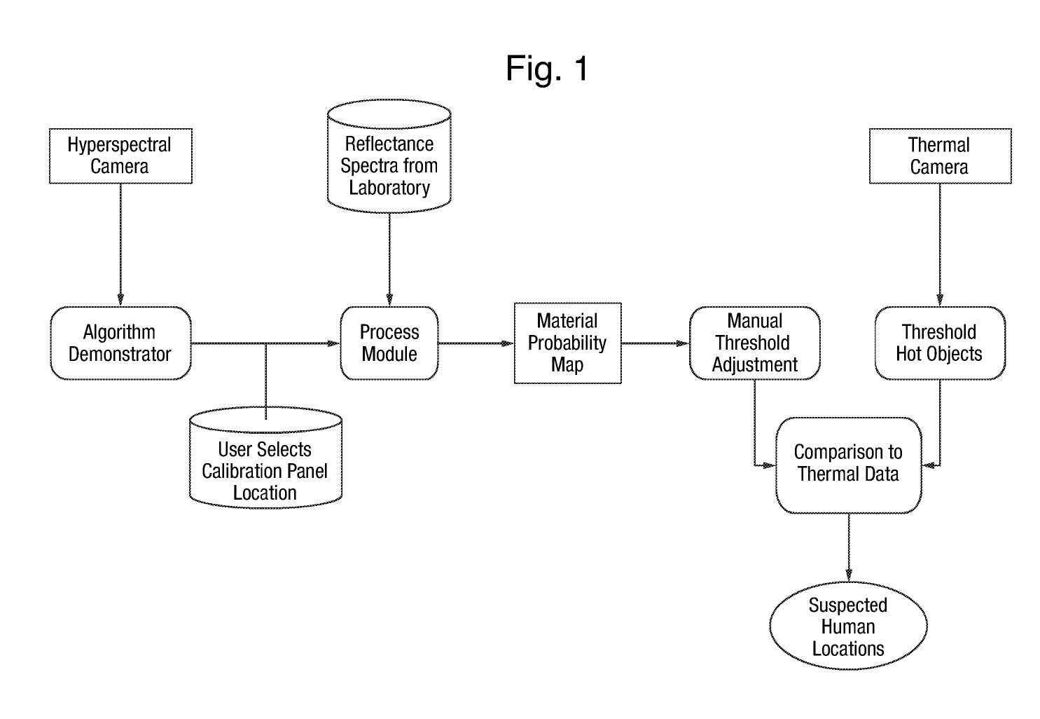

FIG. 1 is schematic illustration of the system according to an embodiment of the present invention;

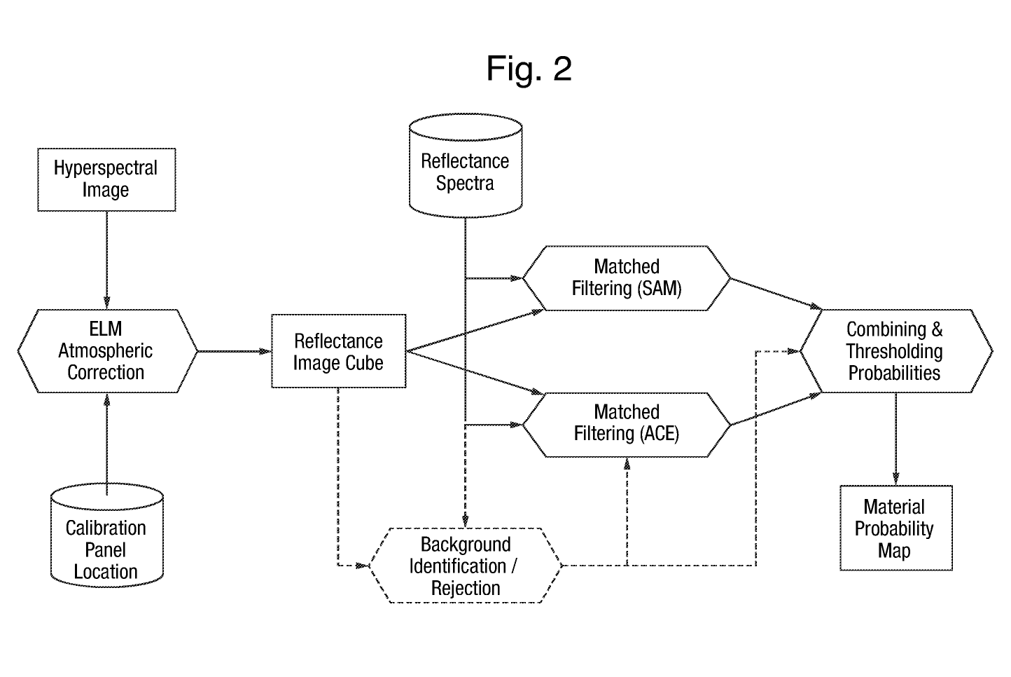

FIG. 2a is schematic illustration of the method according to an embodiment of the present invention;

FIG. 2b is a schematic illustration of the method associated with the data processing step of FIG. 2a;

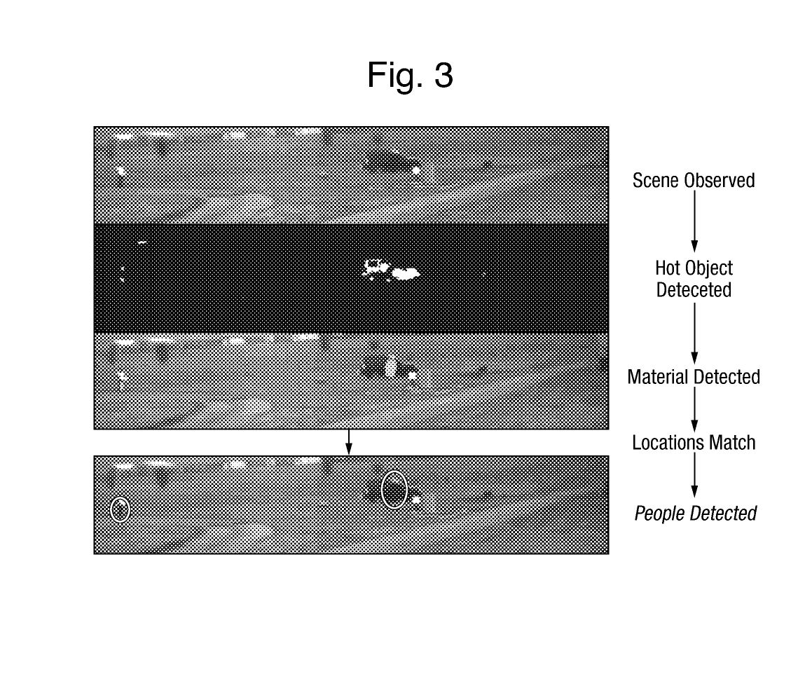

FIG. 3 is a view a scene (a), with the various scene features being highlighted with a thermal imaging system (b), a view of the features highlighted with a system according to an embodiment of the present invention (c) and a view of the location of the targets within the scene (d);

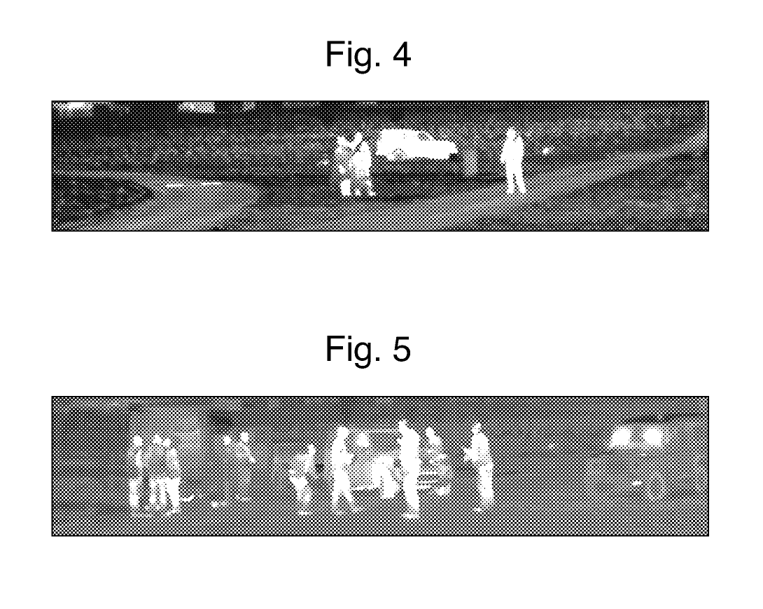

FIG. 4 is a thermal image of targets and a vehicle within a scene;

FIG. 5 is a thermal image of targets and a vehicle within a scene;

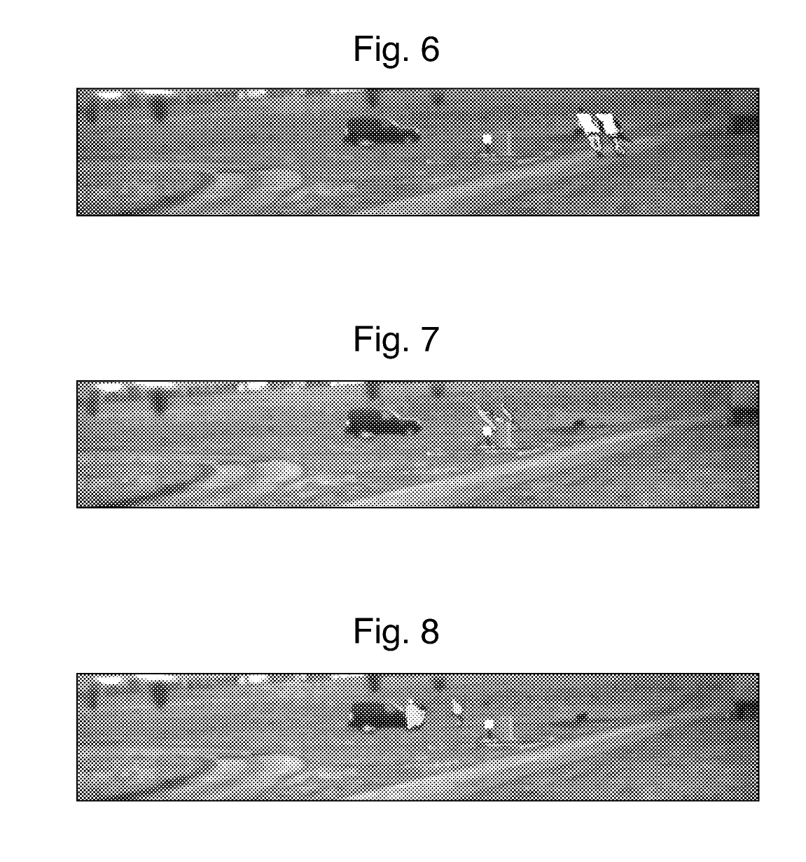

FIG. 6 is a view of a scene with people wearing Hi-Vis jackets, with an overlay of the features detected using a system according to an embodiment of the present invention;

FIG. 7 is a view a scene with various targets, with an overlay of the features detected using a system according to an embodiment of the present invention;

FIG. 8 is a view a scene with various targets, with an overlay of the features detected using a system according to an embodiment of the present invention;

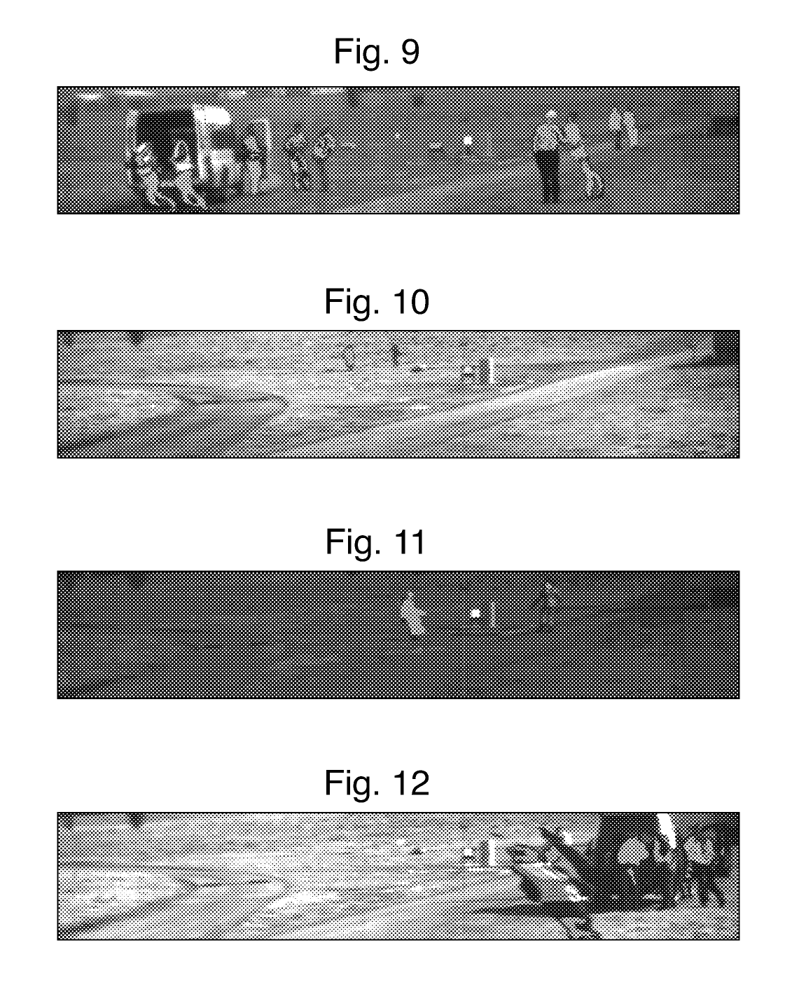

FIG. 9 is view a scene with various targets, with an overlay of the features detected using a system according to an embodiment of the present invention;

FIG. 10 is view a scene with various targets, with an overlay of the features detected using a system according to an embodiment of the present invention;

FIG. 11 is view a scene with various targets, with an overlay of the features detected using a system according to an embodiment of the present invention;

FIG. 12 is view a scene with various targets, with an overlay of the features detected using a system according to an embodiment of the present invention; and,

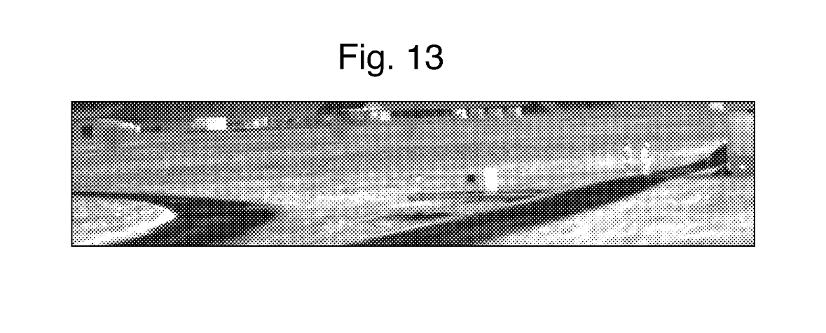

FIG. 13 is thermal image of a scene with various targets, illustrating the challenge of separating people from hot objects.

Referring to FIG. 1 of the drawings, there is illustrated a system 10 according to an embodiment of the present invention for detecting targets within a scene. The system 10 of the present embodiment uses a spectral library of materials associated with human targets (mainly various types of clothing) and a compound matched filtering approach to indicate the location of human targets, namely people. The structure of this system 10 is illustrated in FIG. 1 of the drawings. The system 10 comprises a repository 11 for storing the library of spectra associated with materials which may be worn by people, a sensor 12 for acquiring hyperspectral image data of a scene and a processor 13 for processing the hyperspectral data acquired from the scene. The system 10 further comprises a thermal imaging system or camera 14 for acquiring thermal image data of the scene and a display unit 15 for displaying the hyperspectral and thermal images.

Referring to FIG. 2a of the drawings, there is illustrated a method 100 according to an embodiment of the present invention for detecting a target within a scene. The theory behind the method 100 is that materials which generate spectra similar to those stored in the repository or database 11 can be detected and so if an appropriately large database 11 is used then all people-related material can be detected. Unfortunately, the greater the number of materials there are in the database 11, then the more likely it is for false alarms to be generated, since there is an increased likelihood of a chance match with something else in the scene. These two contradictory facts mean that the balance of materials in the database needs to be carefully managed.

The method 100 according to the present embodiment comprises the initial acquisition of hyperspectral data of the scene at step 110 using the sensor 12, and this data is subsequently corrected at step 120 for atmospheric conditions. The corrected data is then converted at step 130 to reflectance data, which is representative of the objects within the scene and subsequently processed at step 140 to generate a map of the probability that the spectra generated from locations within the scene correspond with one or more target spectra. Thermal image data of the scene is also acquired at step 150 and this thermal image data and converted hyperspectral data is compared at step 160 to generate suspected locations of people targets, and these locations are subsequently displayed via the display unit 15 at step 170.

It is an important requirement that the observed hyperspectral image data from the scene is converted to source reflectance, and this requires some method of atmospheric correction, which is achieved using an Empirical Line Method (ELM). This ELM was chosen because of its simplicity and reliable performance, however, the correction requires a known calibration panel (not shown) to be present in scene, which may not be possible for an in-theatre scenario. Accordingly, the skilled reader will appreciate that other methods of atmospheric correction could be applied to suit the particular scenario.

FIG. 2b expands in greater detail the method employed to process the data at step 140 and produce the probability map. The pseudo-code for implementing the algorithm used to process the data and generate the map is included in Appendix A. Referring to FIG. 2b of the drawings, the processing of the objects within the scene with the database 11 of known target spectra, comprises the use of two different algorithms to search for each stored spectra within the scene, according to a matched filter processing technique, and this is performed at step 141. These algorithms include an Adaptive Cosine Estimator (ACE) and a Spectral Angle Mapper (SAM); the results from these are then combined into the overall probability map that the detected objects within the scene comprise the desired targets, namely people in this embodiment. Each of these two differing approaches performs better under different conditions and by using both the strengths of one can compensate for the weaknesses in the other, thus giving an overall more consistently accurate result.

The method 100 also provides a facility to select from one of a number of distinct background types for the observed scene at step 142, which improves the results of the ACE algorithm by giving a more accurate estimation of the background covariance. Accurate background identification requires specific knowledge about the materials present in the scene and as such the background region selection is typically performed manually. The skilled person will recognise however, that this may be performed automatically, although this will require the background to be spectrally measured and the detection correctly setup when the system 10 is deployed, as opposed to using a background material database.

The results of the various matched filters are subsequently combined by first thresholding each result at step 143 to remove objects which are not of interest. These results are then weighted at step 144 and combined at step 145 together to give the final likelihood estimate.

The material spectra which form part of the database or repository 11 of spectra were captured under controlled laboratory conditions. By including a Spectralon calibration panel (not shown) in the lab measurements, it was possible to convert the measured signal into a reflectance measure for each material. These spectra form the basis of the repository. The materials included in the original acquisition of spectra are considered to provide a reasonable subset of target materials which are likely to be used in a typical battle scenario. The materials included both camouflaged materials and a black nylon poncho. Other materials included coloured t-shirts, black suits and human skin.

In addition to the spectra of the materials themselves, the thresholds which must be applied to each material at various stages of the algorithm must be set. These were been determined on the basis of test imagery and are set at such a level as to maximise the detection of both the target material and similar objects or features within the scene, while still excluding substantially different objects. This differs to the conventional approach to hyperspectral detection, in which quite high thresholds are used to exclude similar materials and remove any false alarms, resulting in pure and accurate detections, but with an increased risk of missing valid targets. Because the chosen approach looks for materials spectrally near to the desired type of target, such as people, the chances of missing a target are reduced but at the cost of a higher quantity of false alarms. These false alarms must be removed by comparing the detection results across all materials in the database and weighting the results to show the likelihood that any given pixel contains a near ‘target’ spectrum.

The final step 146 of the method 100 sets a global threshold over the final weighted likelihood map. This is necessary to remove false alarms as well as give more control over the certainty of a correct result.

Preliminary tests of the system 10 involved placing a range of clothing material outside and using the hyperspectral data collected, to test the system 10, as well as to assist in setting the various material thresholds required. These preliminary tests were undertaken using a sensor 12 operable in both visible and near infra-red (VNIR) region of the electromagnetic (EM) spectrum, and a sensor 12 operable in the short wave infra-red (SWIR) region of the EM spectrum, and showed that the approach can work with either range of waveband, although the system 10 was more reliable using the VNIR waveband. The thermal camera 14 was also used during the tests to allow a direct comparison with the current methods in use.

During the first test, the system 10 was positioned to observe a location where activity would occur during the battle scenarios being played out that day. The weather conditions were heavy cloud cover throughout the day, which provides a consistent and somewhat diffuse level of lighting, ideal for hyperspectral imaging. Both scenarios occurring during the day were of the same type which involved a car driving past, then later the car parking in the location while the occupants get out and walk around the immediate vicinity. Additional data was gathered using targets of opportunity which occurred throughout the day.

FIG. 3a provides a typical view of the scene, whereas FIG. 3b provides a thermal image of the same scene. The features highlighted in red in FIG. 3c correspond with the “targets” detected using the hyperspectral imaging method 100 and FIG. 3d is a view of the original scene with the targets (circled) verified by comparison of the hyperspectral imaging method 100 and the thermal imaging. Upon referring to FIG. 3b, it is evident that the thermal camera 14 is confused with the presence of the vehicle, but the hyperspectral sensor 12 manages to pick out the two people standing just in front of the vehicle. This gives the final detection result a much higher level of certainty than either thermal or hyperspectral alone.

Throughout the first test the thermal camera 14 performed very consistently as shown in FIG. 4 and FIG. 5 of the drawings, which illustrate thermal images of two scenarios. The camera 14 was able to detect hot objects (white/orange-hot, black/purple-cold) such as the vehicles, but struggled to separate the person wearing the black poncho (left most person in FIG. 4) from the background. This is because the poncho was not worn for a long time and was also loose fitting, leaving it nearer to the ambient temperature than other clothing.

FIGS. 6 to 9 show some results of the system 10 throughout the first test, with the regions detected as ‘people’ highlighted in red. The hyperspectral sensor 12 also performed consistently during the first test, reliably detecting the majority of clothing items present in the scene. Although some consistent false alarms were present in the material likelihood map, these objects could be reliably removed by both varying the secondary threshold and performing simple clustering on the results; the clustering in particular was very good at removing lone pixel detection which occurred on occasion. Other high likelihood objects did include items with strong colours, such as a blue plastic sheet in view, and very dark shadowy areas; correctly setting the secondary threshold could remove the presence of these objects in most cases. It was also noticeable that the hyperspectral images of moving objects tend to adopt a pronounced “lean” or become distorted on the viewed screen 15. This is simply an artefact of the particular imager used on the trials, which gathers images line-by-line at a relatively slow frame rate.

The clothing materials that were not detected also sheds light on the system 10 and method 100. For example, a common item that was not detected is the fluorescent yellow Hi-Vis jackets (see FIG. 6). These items have a strong signature and can be very reliably detected via hyperspectral techniques, however no Hi-Vis material was included in the database 11 and their strong and unique spectra means that such items are not detected as ‘near’ to any of the spectra searched for. In most cases, missing one of the items of clothing a particular person was wearing still resulted in a detection result due to other worn items, or skin, being identified. This seems to indicate that as long as the database 11 is appropriately setup for any scene then a substantial subset of clothing items can be reliably detected.

During the second test three scenarios where played out, one being the scenario observed during the first test and the other two consisting of a car and a person passing briefly through the scene on a few occasions. Additional data was gathered using targets of opportunity which occurred throughout the test. The weather during the second test was brighter with less cloud cover, meaning that the effect of sunlight “glints” was much more pronounced than the first test. Additionally the passage of clouds meant that illumination levels were varying throughout the second test (on occasion rapidly) which makes setting a good exposure more challenging.

FIGS. 10 to 12 show some example results from second test. The materials worn by actors in the battle scenario was different from previously, but was still generally detectable using the hyperspectral method 100. A notable difference was that a specific variety of camouflage jacket used for this test could not be detected (FIG. 11) whereas the one in use during the first test was consistently identified (FIG. 8). This is thought to be because the camouflage in the database is of the green/brown (i.e. standard/forest) kind and the jacket during the second test was a more yellow/tan (i.e. desert) variety. The varying light levels appears to have made the detection of some materials using the thermal camera 14 more challenging as shown in FIG. 13. Although the hyperspectral system 10 required its exposure to be correctly adjusted, a well exposed image still gave a good result.

The system 10 and method 100 developed under this work performed well during both tests. The database detection method has performed well at detecting a broad selection of people objects, of which only a very limited number were included specifically in the database. The algorithm failed to detect certain people objects, such as fluorescent jackets, but this is known to be due to the spectra of such objects being considerably different from anything present in the database. Other objects did show up on the likelihood map, mainly those with either strong colours (e.g. blue plastic waterproofing) or dark, shadowed regions (e.g. underneath the cabin and some trees). These could be reliably removed by applying the threshold as their likelihood index was lower than actual people targets. The appearance of these objects in the likelihood map is due to spectral similarities to some of the database spectra; this demonstrates the requirement for the overall threshold stage.

This system 10 and method 100 according to the present embodiment could also be deployed alongside other sensor methods, and is not restricted to working only alongside thermal imagery, as was done for this work. The system 10 could be triggered by some kind of event detector, such as pattern of life tools, to identify whether such an event involves people or not. The system 10 could also be used to trigger further sensors; for example having a highly zoomed camera (not shown) directed to any regions detected as having a high likelihood of containing people, both for further confirmation and for a greater amount of detail as to what they are actually doing.

Before the system 10 could be deployed into a real scenario, it is envisaged that several adjustments would have to be made. Firstly, the atmospheric correction routine would have to be replaced with a method more suitable to the style of deployment. In addition, automated background selection could be employed by making a secondary database (not shown) of the kind of background materials expected. Finally, the exact makeup of the material database would have to be tuned to the expected makeup of targets; ensuring that the materials are appropriate to the expected targets will give much better performance than a completely generic, and possibly very large, database.

Overall, the good performance of the system demonstrates that a database of spectra and processing techniques can identify the broad spectral range of materials which can indicate people targets. This information can then be compared to other sensors (i.e. thermal imagery) to give a much higher level of confidence for the number and location of people targets.

Appendix A—Pseudo-Code For Detection Method

A.1 Database Creation/Setup

Capture hyperspectral images of a series of representative materials under short range, controlled laboratory conditions.

Select representative spectra for each material/colour material (average across consistent area). Multi coloured items (i.e. camouflage) should have multiple spectra, one of an average of all colours and some focussing on regions only of a single colour.

Convert representative spectra to reflectance values.

Assign loose thresholds for SAM and ACE to each material spectrum. (SAM˜0.1-0.15, ACE˜0.1-0.25)

Store spectra and settings in a configuration file for use.

A.2 Generation of Material Likelihood Map

Load configuration file (Settings and Spectra).

Load hyperspectral image (from memory or from live camera).

Convert hyperspectral image to reflectance.

Current method uses ELM. User must identify calibration panel location. If this has been done for previous cube the system assumes the calibration panel has not been moved and uses this location.

Perform SAM detection for all database spectra.

Set all SAM result values for each spectrum, greater than material SAM threshold, to 1.

Perform ACE detection for all database spectra.

ACE results may improve by restricting the covariance calculation to only include background materials.

Current method has the option for the user to select a region of only background materials for this purpose. This stage is advised but not required.

Set all ACE result values for each spectrum, less than material ACE threshold, to 0.

Sum all √ACE results and all 1-SAM results.

Multiply result by normalisation factor to generate final material likelihood map.

A.3 Further Visual Processing

For ease of visualization/use the following extra stages may be applied.

Threshold likelihood map (all values greater than variable threshold show as people)

Perform simple clustering on thresholded results

1. A method of detecting a target within a scene, the method comprising:
acquiring hyperspectral image data of a scene;
processing the hyperspectral image data to compare spectra generated from locations within the scene with a known set of target spectra; and
generating a map of a probability that the spectra generated from locations within the scene correspond with one or more target spectra, based on the comparison between the spectra generated from locations within the scene with the target spectra.

2. A method according to claim 1, wherein the hyperspectral image data is converted to reflectance data, characteristic of objects within the scene.

3. A method according to claim 1, further comprising highlighting the targets identified from the hyperspectral image data on a view of the scene.

4. A method according to claim 1, wherein the processing of the hyperspectral image data comprises matched filter processing.

5. A method according to claim 4, wherein the matched filter processing comprises two separate techniques for comparing spectra generated from locations within the scene with the known set of target specific spectra.

6. A method according to claim 5, wherein the separate comparison techniques separately comprise relating a level of comparison to a threshold.

7. A method according to claim 5, wherein the matched filter processing comprises the use of an adaptive cosine estimator and a spectral angle mapper.

8. A method according to claim 1, further comprising selecting a background of the scene from a plurality of types of scene backgrounds.

9. A method according to claim 1, further comprising calibrating the hyperspectral image data according to atmospheric conditions.

10. A method according to claim 1, further comprising acquiring thermal image data of the scene and comparing the targets identified using the hyperspectral image data with targets identified using the thermal image data.

11. A system for detecting a target within a scene, the system comprising:
a sensor for acquiring hyperspectral image data of the scene;
a repository for storing a set of target spectra; and
a processor for processing spectra generated from locations within scene with the stored set of target spectra, the processor being further arranged to generate a probability that the spectra generated from locations within the scene correspond with one or more target spectra.

12. A system according to claim 11, further comprising a thermal imaging sensor for acquiring thermal image data of the scene.

13. A system according to claim 11, further comprising a display for displaying a view of the scene.

14. A system according to claim 13, wherein the display is further arranged to display the location of targets identified from the hyperspectral image data and the thermal image data.

15. A system according to claim 11, wherein the hyperspectral image data is converted to reflectance data, characteristic of objects within the scene.

16. A system according to claim 11, wherein the processor is further configured to cause highlighting the targets identified from the hyperspectral image data on a view of the scene.

17. A system according to claim 11, wherein the processing of the spectra comprises matched filter processing of acquired hyperspectral image data.

18. A system according to claim 17, wherein the matched filter processing comprises two separate techniques for comparing spectra generated from locations within the scene with the known set of target specific spectra.

19. A system according to claim 18, wherein the separate comparison techniques separately comprise relating a level of comparison to a threshold.

20. A system according to claim 17, wherein the matched filter processing comprises the use of an adaptive cosine estimator and a spectral angle mapper.
